(19) United States
(12) Patent Application Publication
(10) Pub. No.: US 2021/0175545 A1
(43) Pub. Date: Jun. 10, 2021

(54) ELECTROLYTE FOR LITHIUM METAL BATTERY FORMING STABLE FILM AND LITHIUM METAL BATTERY COMPRISING SAME

(71) Applicants: HYUNDAI MOTOR COMPANY, SEOUL (KR); KIA MOTORS CORPORATION, SEOUL (KR); ULSAN NATIONAL INSTITUTE OF SCIENCE AND TECHNOLOGY, ULSAN (KR)

(72) Inventors: Ji Yong Lee, Seongnam-si (KR); Jong Chan Song, Suwon-si (KR); Won Joon Lee, Ulsan (KR); Sae Hun Kim, Ulsan (KR); Min Young Lee, Ulsan (KR); Nam Soon Choi, Ulsan (KR); Young Joon Ahn, Ulsan (KR)

(21) Appl. No.: 16/878,789

(22) Filed: May 20, 2020

(30) Foreign Application Priority Data
Dec. 10, 2019 (KR) 10-2019-0163256

(51) Int. Cl. H01M 10/0567; H01M 10/052; H01M 10/0569; H01M 10/0568; H01M 4/36; H01M 4/62

(52) U.S. Cl. CPC H01M 10/0567; H01M 10/052; H01M 10/0569; H01M 2004/027; H01M 4/366; H01M 4/628; H01M 10/0568

(57) ABSTRACT

The present disclosure relates to an electrolyte for a lithium metal battery including a reductive decomposable additive for forming a stable film, and a lithium metal battery including the same. The electrolyte for the lithium metal battery includes lithium nitrate (LiNO₃) and lithium difluorobis(oxalate) phosphate (LiDFBP) as a reductive decomposable additive, so that a stable protective film is formed on the surface of a metal anode. Accordingly, mechanical properties are improved so as to withstand lithium volume expansion under a high-specific-capacity condition, and ion conductivity is improved under a high-current-density condition, thereby improving the stability and performance of the lithium metal battery including the protective film.

### CROSS REFERENCE TO RELATED APPLICATIONS

The present application claims priority based on Korean Patent Application No. 10-2019-0163256, filed on Dec. 10, 2019, the entire content of which is incorporated herein for all purposes by this reference.

### BACKGROUND

### 1. Field

The present disclosure relates to an electrolyte for a lithium metal battery including a reductive decomposable additive to form a stable film, and a lithium metal battery including the same.

### 2. Description of the Related Art

With the rapid development of the electrical, electronics, telecommunications, and computer industries, the demand for high-performance and safe secondary batteries has recently increased rapidly. In particular, secondary batteries, which are key components, are also required to be lighter in weight and smaller in size according to the trend toward light, slim, short, small, and portable electric and electronic products. Further, as the need for new energy markets arises due to the exhaustion of oil and environmental pollution, such as air pollution and noise, according to the mass distribution of automobiles, the necessity to develop electric vehicles that can solve these problems has increased. As a power source thereof, the development of batteries having high power and high energy density has been demanded.

One of the next-generation high-performance batteries that have recently been spotlighted in response to such demands is a lithium metal battery. The lithium metal battery is a battery that includes lithium metal or a lithium alloy as an anode, and is considered one of attractive materials due to the very high theoretical energy capacity thereof.

However, in the case of the lithium metal battery, lithium is deposited only on specific portions due to the non-uniform current distribution on the surface of a lithium electrode, which may cause formation of a lithium dendrite, which is a dendritic precipitate. The lithium dendrite passes through a separator to reach a cathode, which may short-circuit the battery or cause an explosion of the battery.

Further, a lithium metal anode has a very high reactivity, so that an electrolytic solution may be reductively decomposed to form a solid electrolyte interface layer (SEI) at the interface with the lithium metal. The formed film causes various problems such as non-uniform current distribution, low ion conductivity, and low mechanical strength. Accordingly, there is a problem of deterioration in performance such as depletion of the electrolytic solution of lithium metal batteries and poor stability due to non-uniform electrodeposition of lithium.

Therefore, there is a need for an electrolyte material capable of forming a stable film that stabilizes the interface between lithium metal and the electrolyte.

### SUMMARY

Accordingly, the present disclosure has been made keeping in mind the above problems occurring in the related art, and specific objects of the present disclosure are as follows.

An object of the present disclosure is to provide an electrolyte for a lithium metal battery. The electrolyte includes a lithium salt, an organic solvent, and a reductive decomposable additive. The reductive decomposable additive is reductively decomposed before the organic solvent is decomposed, thus forming a protective film on the surface of a lithium metal anode.

Another object of the present disclosure is to provide a lithium metal battery including a protective film containing a reductive decomposition material of a reductive decomposable additive.

The objects of the present disclosure are not limited to the above-mentioned objects. The objects of the present disclosure will become more apparent from the following description, and will be realized by the means described in the claims and combinations thereof.

An electrolyte for a lithium metal battery according to an embodiment of the present disclosure includes a lithium salt, an organic solvent, and a reductive decomposable additive. The reductive decomposable additive includes lithium nitrate (LiNO₃) and lithium difluorobis(oxalate) phosphate (LiDFBP), and the reductive decomposable additive is reductively decomposed before the organic solvent is decomposed, thus forming a protective film on the surface of a lithium metal anode.

The reductive decomposable additive may be included with a content of 0.1 to 10 wt % based on 100 wt % of the total weight of the electrolyte for the lithium metal battery.

A mass ratio of lithium nitrate (LiNO₃) to lithium difluorobis(oxalate) phosphate (LiDFBP) included in the reductive decomposable additive may be 4 to 6:1.

The lithium salt may be included with a concentration of 1.5 to 3 mol per 1 L of the electrolyte for the lithium metal battery.

The lithium salt may include one or more selected from the group consisting of LiFSI, LiTFSI, LiPF₆, LiBF₄, LiSbF₆, LiAsF₆, LiN(SO₂CF₃)₂, LiN(SO₃C₂F₅)₂, LiC₄F₉SO₃, LiClO₄, LiAlO₂, LiAlCl₄, LiCl, and LiI.

The organic solvent may include one or more selected from the group consisting of dimethyl ether (DME), 1,2-dimethoxyethane, 1,3-dioxolane, diethylene glycol, tetraethylene glycol, diethylene glycol dimethyl ether, triethylene glycol dimethyl ether, and tetraethylene glycol dimethyl ether.

A lithium metal battery according to an embodiment of the present disclosure includes a cathode, an anode, the electrolyte for the lithium metal battery, and a protective film formed on the surface of the anode. The protective film includes reductive decomposition materials of lithium nitrate (LiNO₃) and lithium difluorobis(oxalate) phosphate (LiDFBP).

The protective film may stabilize the interface between a lithium metal anode and the electrolyte for the lithium metal battery.

The reductive decomposition materials may include one or more selected from the group consisting of LiF, Li₃N, and LiₓPO_{y}F_{z} (0.1≤x≤1, 2≤y≤3, 1≤z≤2) in a large amount.

The LiF may be mainly distributed on the inner side of a protective film adjacent to the lithium metal battery.

The Li₃N may be uniformly distributed throughout the protective film.

The LiₓPO_{y}F_{z} (0.1≤x≤1, 2≤y≤3, 1≤z≤2) may be distributed throughout the protective film and mainly distributed on the inner side of the protective film adjacent to the lithium metal battery.

The electrolyte for a lithium metal battery according to the present disclosure includes lithium nitrate (LiNO₃) and lithium difluorobis(oxalate) phosphate (LiDFBP) as a reductive decomposable additive so that a stable protective film is formed on the surface of a metal anode. Accordingly, mechanical properties are improved so as to withstand lithium volume expansion under a high-specific-capacity condition, and ion conductivity is improved under a high-current-density condition, thereby improving the stability and performance of the lithium metal battery including the protective film.

The effects of the present disclosure are not limited to the effects mentioned above. It is to be understood that the effects of the present disclosure include all the effects deduced from the description below.

### BRIEF DESCRIPTION OF THE FIGURES

The above and other objects, features and advantages of the present disclosure will be more clearly understood from the following detailed description taken in conjunction with the accompanying drawings, in which:

FIG. 1 is across-sectional view showing that a reductive decomposition material according to an embodiment of the present disclosure is distributed in a protective film;

FIG. 2A is a SEM image showing the lithium electrodeposition morphology of a lithium metal battery manufactured in Comparative Example 3;

FIG. 2B is a SEM image showing the lithium electrode position morphology of a lithium metal battery manufactured in Comparative Example 1;

FIG. 2C is a SEM image showing the lithium electrode position morphology of a lithium metal battery manufactured in Example 1;

FIG. 3 is a view showing the results obtained by observing the surfaces of the lithium metal anodes of the lithium metal batteries, which are manufactured in Example 1 and Comparative Examples 1 and 3, according to the TOF-SIMS evaluation;

FIG. 4 are graphs showing the results obtained by observing the surfaces of the lithium metal anodes of the lithium metal batteries, which are manufactured in Example 1 and Comparative Examples 1 and 3, through the XPS spectra around F 1s;

FIG. 5 are graphs showing the results obtained by observing the surfaces of the lithium metal anodes of the lithium metal batteries, which are manufactured in Example 1 and Comparative Examples 1 and 3, through the XPS spectra around N 1s;

FIG. 6 are graphs showing the results obtained by observing the surfaces of the lithium metal anodes of the lithium metal batteries, which are manufactured in Example 1 and Comparative Examples 1 and 3, through the XPS spectra around S 2p;

FIG. 7 are graphs showing the results obtained by observing the surfaces of the lithium metal anodes of the lithium metal batteries manufactured in Example 1 and Comparative Examples 1 and 3 after seven cycles are performed, through the XPS spectra around F 1s;

FIG. 8 are graphs showing the results obtained by observing the surfaces of the lithium metal anodes of the lithium metal batteries manufactured in Example 1 and Comparative Examples 1 and 3 after seven cycles are performed, through the XPS spectra around N 1s;

FIG. 9 are graphs showing the results obtained by observing the surfaces of the lithium metal anodes of the lithium metal batteries manufactured in Example 1 and Comparative Examples 1 and 3 after seven cycles are performed, through the XPS spectra around S 2p; and

FIG. 10 is a graph showing the results obtained by observing the surface of the lithium metal anode of the lithium metal battery manufactured in Example 1 after seven cycles are performed, through the XPS spectra around P 2p.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

It will be understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Electrolyte for Lithium Metal Battery

In the present specification, an electrolyte for a lithium metal battery is not particularly limited, as long as the electrolyte is an electrolyte capable of forming a stable film on a lithium metal anode while performing a natural function in the lithium metal battery.

The electrolyte for the lithium metal battery according to the present disclosure includes a lithium salt, an organic solvent, and a reductive decomposable additive.

### (1) Lithium Salt

The lithium salt according to an embodiment of the present disclosure is not particularly limited, as long as the lithium salt is a material that functions as a source of lithium ions in the battery to enable the basic operation of the lithium metal battery and to promote the movement of lithium ions between a cathode and an anode.

The lithium salt according to the present disclosure may include commonly known lithium salts that may be used in the present disclosure, for example, one or more selected from the group consisting of LiFSI, LiTFSI, LiPF₆, LiBF₄, LiSbF₆, LiAsF₆, LiN(SO₂CF₃)₂, LiN(SO₃C₂F₅)₂, LiC₄F₉SO₃, LiClO₄, LiAlO₂, LiAlCl₄, LiCl, LiN(CₓF₂ₓ₋₁SO₂)(C_{y}F_{2y-1}SO₂) (x and y being natural numbers), and LiI, and is not limited to specific components. Preferably, LiFSI is used as the lithium salt, and LiFSI is easy to ionize (dissociate) in an organic solvent used due to the low binding energy of the lithium salt, does not generate acidic compounds such as HF, and provides a fluorine atom to a lithium metal anode so that an inorganic film component having excellent mechanical strength such as LiF is formed.

The lithium salt may be included with a concentration of 1.5 to 3 mol per 1 L of the electrolyte for the lithium metal battery. When the concentration of the lithium salt is less than 1.5 mol per 1 L of the electrolyte for the lithium metal battery, free solvent that does not have an ion-dipole interaction with excessive lithium ions is present, resulting in an increase in side reactions on the surface of the lithium metal anode. Accordingly, since the electrolytic solution is consumed, the amount of the electrolytic solution in the battery becomes less than that required, which increases the resistance of the battery and leads to continuous accumulation of decomposition products generated by side reactions. Therefore, there is a drawback in that the utilization rate of lithium is reduced. When the concentration of the lithium salt is more than 3 mol per 1 L of the electrolyte for the lithium metal battery, there is a problem in that the resistance of the battery is increased due to the viscosity of the electrolytic solution caused by the increase of the ion-dipole interaction between lithium ions and the solvent, which results in a drawback of reduced output of the battery.

### (2) Organic Solvent

The organic solvent according to an embodiment of the present disclosure is a nonpolar solvent, and is not particularly limited as long as the organic solvent is capable of appropriately dispersing a lithium salt and a reductive decomposable additive.

The organic solvent according to the present disclosure may include a commonly known organic solvent that may be used in the present disclosure, for example, one or more selected from the group consisting of dimethyl ether (DME), 1,2-dimethoxyethane, 1,3-dioxolane, diethylene glycol, tetraethylene glycol, diethylene glycol dimethyl ether, triethylene glycol dimethyl ether, and tetraethylene glycol dimethyl ether as an organic solvent including an ether group, and one or more selected from the group consisting of monofluoroethylene carbonate, difluoroethylene carbonate, and fluoropropylene carbonate as an organic solvent including fluorine. The organic solvents may be used alone or in a mixture of one or more thereof. When the mixture of one or more organic solvents is used, the mixing ratio may be appropriately adjusted according to the desired battery performance, and the organic solvent is not limited to including any specific component. Preferably, the organic solvent may be dimethyl ether (DME), which includes an ether group that readily dissociates with the lithium salt and also having low reactivity to the lithium metal anode.

### (3) Reductive Decomposable Additive

The reductive decomposable additive according to an embodiment of the present disclosure is a material which is reductively decomposed in a metal-based anode before the solvent is decomposed. The reductive decomposable additive is not particularly limited, as long as the reductive decomposable additive includes a material capable of forming a kind of protective film.

The reductive decomposable additive according to the present disclosure may be a commonly known reductive decomposable additive useful in the present disclosure, for example, one or more selected from the group consisting of lithium nitrate (LiNO₃), lithium difluorobis(oxalate) phosphate (LiDFBP), fluoroethylene carbonate (FEC), and lithium difluoro(oxalato)borate (LiDFOB), as a material having a reductive decomposition tendency higher than that of the solvent, and the reductive decomposable additive is not limited to including any specific component. Preferably, the reductive decomposable additive may include lithium nitrate (LiNO₃), which is capable of forming a Li₃N film, and may also include lithium difluorobis(oxalate) phosphate (LiDFBP), which is capable of forming a film including a LiF component having excellent mechanical properties to accommodate the volume change of the lithium metal anode and a highly polar phosphor (P) element capable of facilitating the mobility of lithium ions.

The reductive decomposable additive according to the present disclosure may be included with a content of 0.1 to 10 wt % based on 100 wt % of the total weight of the electrolyte for the lithium metal battery. When the content of the reductive decomposable additive is less than 0.1 wt %, there is a drawback in that the generated protective film components do not cover the entire surface of the lithium metal anode. When the content is more than 10 wt %, there is a drawback in that the thickness of the protective film is increased more than necessary in order to increase the resistance.

The mass ratio of lithium nitrate (LiNO₃) tolithium difluorobis(oxalate) phosphate (LiDFBP) included in the reductive decomposable additive according to the present disclosure may be 4 to 6:1. When the mass ratio is less than 4:1, Li₃N for facilitating the movement of the lithium ions in the protective film is not sufficiently formed, resulting in a drawback of reduced lithium ion mobility. When the mass ratio is more than 6:1, there is a problem in that the additive is not dissolved in the electrolytic solution.

Nitrate (LiNO₃) and lithium difluorobis(oxalate) phosphate (LiDFBP) included in the reductive decomposable additive according to the present disclosure serve to form a stable protective film on the surface of the lithium metal anode, thus improving mechanical properties so as to withstand lithium volume expansion under a high-specific-capacity condition and also improving ion conductivity under a high-current-density condition.

### Lithium Metal Battery

The lithium metal battery according to an embodiment of the present disclosure may include a cathode, an anode, the electrolyte for the lithium metal battery of any one of claims 1 to 6, and a protective film formed on the surface of the anode.

The lithium metal battery according to the present disclosure is not limited to have a specific shape, and may have any shape, such as that of a cylinder or a pouch, that includes an electrolytic solution according to an embodiment and which is capable of operating as a battery.

The anode according to an embodiment of the present disclosure may include at least one selected from lithium metal and a lithium alloy. As the lithium alloy, an alloy including lithium and at least one metal selected from among Na, K, Rb, Cs, Fr, Be, Mg, Ca, Sr, Ba, Ra, Al, and Sn may be used.

The surface of the lithium metal according to the present disclosure may include a protective film. The protective film may include the decomposition materials of the electrolyte, preferably the reductive decomposition materials of lithium nitrate (LiNO₃) and lithium difluorobis(oxalate) phosphate (LiDFBP) included in the reductive decomposable additive of the electrolyte.

The reductive decomposition materials according to the present disclosure may include one or more selected from the group consisting of LiF, Li₃N, LiNₓO_{y} (0.5≤x≤1, 3≤y≤3.5), and LiₓPO_{y}F_{z} (0.1≤x≤1, 2≤y≤3, 1≤z≤2) in a large amount.

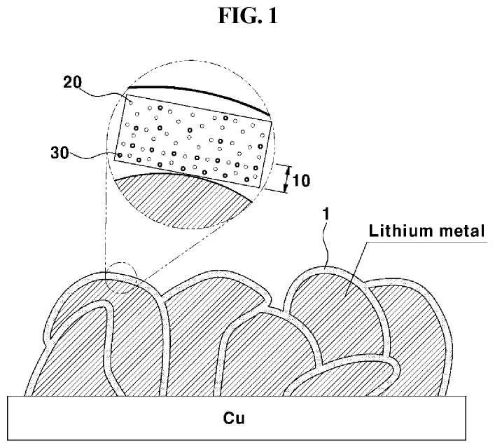

FIG. 1 is a cross-sectional view showing that the reductive decomposition materials according to the present disclosure are distributed in a protective film 1. Referring to this, LiF 10 may be mainly distributed on the inner side of the protective film adjacent to the lithium metal battery. Further, Li₃N 20 may be uniformly distributed throughout the protective film. Further, LiₓPO_{y}F_{z} (0.1≤x≤1, 2≤y≤3, 1≤z≤2) 30 may be distributed throughout the protective film, and may be mainly distributed on the inner side of the protective film adjacent to the lithium metal battery, thereby stabilizing the interface between the lithium metal anode and the electrolyte for the lithium metal battery.

That is, LiF and LiₓPO_{y}F_{z} (0.1≤x≤1, 2≤y≤3, 1≤z≤2) of the reductive decomposition materials in the protective film according to the present disclosure may be mainly distributed on the inner side of the protective film adjacent to the lithium metal battery, thereby improving the ion conductivity and also improving mechanical properties so as to withstand lithium volume expansion under a high-specific-capacity condition. The Li₃N may be uniformly distributed throughout the protective film, thereby improving mechanical properties and ion conductivity under a high-current-density condition.

The cathode according to an embodiment of the present disclosure may include a current collector and a cathode active material layer formed in the current collector.

The current collector may be, for example, an aluminum current collector, but is not limited thereto.

The cathode active material layer may include at least one cathode active material selected from a sulfur element and a compound containing sulfur, a binder, and optionally a conductive material. The lithium metal battery containing the cathode active material is also called a lithium sulfur battery. As the compound containing sulfur, for example, at least one selected from among Li₂Sn (n=1), disulfide compounds such as 2,5-dimercapto-1,3,4-thiadiazole and 1,3,5-trithiocyanuic acid, an organic sulfur compound, and a carbon-sulfur polymer ((C₂Sₓ)ₙ, x=2.5 to 50, n=2) may be used.

Further, the cathode may be exposed to ambient air to manufacture a lithium metal battery. The cathode active material layer may include carbon and a binder, and optionally a catalyst may be used. The lithium metal battery including the cathode that is designed in the above-described manner is also called a lithium air battery.

Further, of course, a compound (lithiated intercalation compound) which is generally used in the lithium ion battery and is capable of performing reversible intercalation and deintercalation of lithium may be used as the cathode active material.

Further, the binder serves to adhere the cathode active material particles to each other and to securely adhere the cathode active material to the current collector. Specific examples thereof may include polyvinyl alcohol, carboxymethyl cellulose, hydroxypropyl cellulose, diacetyl cellulose, polyvinyl chloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, polyamideimide, and polyacrylic acid, but are not limited thereto.

The conductive material is used to impart conductivity to an electrode, and any material is capable of being used as long as the material is an electronic conductive material that does not cause a chemical change in the constituent battery. Examples thereof may include natural graphite, artificial graphite, carbon black, acetylene black, Ketjen black, carbon fibers, metal powder such as copper, nickel, aluminum, and silver, and metal fibers. Further, one or more types of conductive materials derived from polyphenylene may be mixed therewith and used.

Hereinafter, the present disclosure will be described in more detail with reference to specific Examples. The following Examples are merely examples to help understanding of the present disclosure, but the scope of the present disclosure is not limited thereto.

### Example 1: Manufacture of Lithium Metal Battery Including Li I Cu Half-Cell

1) Manufacture of electrolytic solution: A solution in which a 2M LiFSI lithium salt was added to a dimethyl ether (DME) solvent was prepared, and an electrolytic solution in which 5 wt % of lithium nitrate (LiNO₃) and 1 wt % of lithium difluorobis(oxalate) phosphate (LiDFBP) were added to the above solution was prepared.

2) Anode and other parts
Anode: 100 μm lithium metal, current collector: Cu foil (15 pi)
Spacer: 0.5T (500 μm) stainless steel disc (15 pi), separator: polyethylene (PE) (porosity 38%, thickness 20 μm)

Subsequently, the current collector, the anode, the spacer, the electrolytic solution, and the polyethylene separator prepared as described above were used to perform compression, thus manufacturing a lithium metal battery using a 2016 coin-type cell.

### Example 2: Manufacture of Lithium Metal Battery Including Li I Li Symmetric Cell

A lithium metal battery was manufactured in the same manner as in Example 1, except that the anode was the Li I Li symmetric cell.

### Comparative Example 1

A lithium metal battery was manufactured in the same manner as in Example 1, except that 1 wt % of lithium difluorobis(oxalate) phosphate (LiDFBP) was not added

### Comparative Example 2

A lithium metal battery was manufactured in the same manner as in Comparative Example 1, except that the anode was the Li I Li symmetric cell.

### Comparative Example 3

A lithium metal battery was manufactured in the same manner as in Example 1, except that 5 wt % of lithium nitrate (LiNO₃) and 1 wt % of lithium difluorobis(oxalate) phosphate (LiDFBP) were not added.

### Comparative Example 4

A lithium metal battery was manufactured in the same manner as in Comparative Example 3, except that the anode was the Li I Li symmetric cell.

### Experimental Example 1: Evaluation of Electrodeposition/Stripping Efficiency and Lifespan of Lithium Metal Battery

The electrodeposition/stripping efficiency and lifespan of the lithium metal batteries manufactured according to Examples 1 and 2 and Comparative Examples 1 to 4 were evaluated according to the following standard, and the results are described in Table 1.

[Evaluation Standard]
Evaluation of electrodeposition/stripping efficiency: capacity (5 mAh cm), current density (0.5 mA cm′)
Evaluation of lifespan: capacity (5 mAh cm⁻²), current density (1 mA cm⁻²: 3 cycles), current density (2 mA cm⁻²: 300 cycles)

TABLE 1

| | 2M LiFSI DME(lithium salt and organic solvent) | | |
|---|---|---|---|
| | | Addition of 5 wt % | Addition of 5 wt % of |
| | Reductive | of LiNO₃ as | LiNO₃ and 1 wt % of |
| | decomposable | reductive | LiDFBP as reductive |
| | additive | decomposable | decomposable |
| | X | additive | additive |
| Evaluation of | 72.7% | 90.5% | 94.8% |
| electrodeposition/stripping | (Comparative | (Comparative | (Example 1) |
| efficiency of Li I Cu half-cell | Example 3) | Example 1) | |
| Lifespan evaluation of Li I Li | 187cycle | 113cycle | 224cycle |
| symmetric cell | (Comparative | (Comparative | (Example 2) |
| | Example 4) | Example 2) | |

Referring to Table 1, it could be confirmed that the electrodeposition/stripping efficiency of the Li I Cu half-cell of the lithium metal battery manufactured according to Comparative Example 3 was the lowest. Accordingly, it could be seen that the DME solvent formed an unstable organic film on the surface of the lithium metal anode.

Meanwhile, it could be confirmed that the electrodeposition/stripping efficiency of the Li I Cu half-cell of the lithium metal battery manufactured according to Example 1 and Comparative Example 1 was higher than that of the lithium metal battery according to Comparative Example 3. Accordingly, it could be seen that a side reaction forming an unstable organic film was reduced, thus increasing the electrodeposition/stripping efficiency.

Further, in the case of lifespan evaluation of the lithium metal batteries manufactured according to Example 2 and Comparative Examples 2 and 4, the lifespan was measured until the voltage reached an over-voltage of 100 mV. As a result, it could be confirmed that the lifespan of the Li I Li symmetric cell manufactured according to Example 2 was greatly superior to that of the Li I Li symmetric cell of Comparative Examples 2 and 4.

### Experimental Example 2: Evaluation of Morphology of Lithium Metal Battery

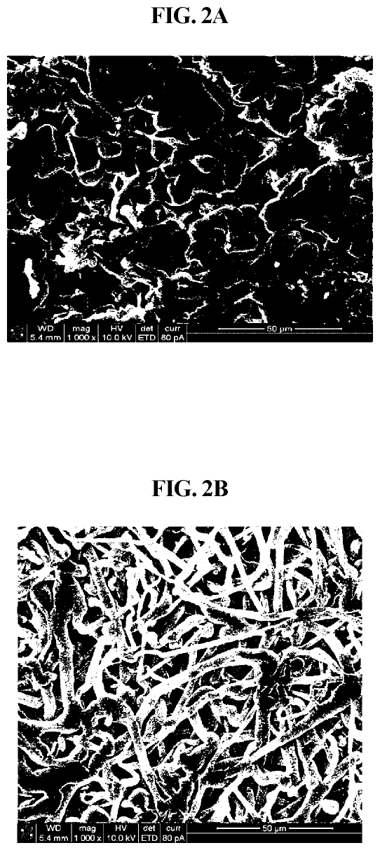

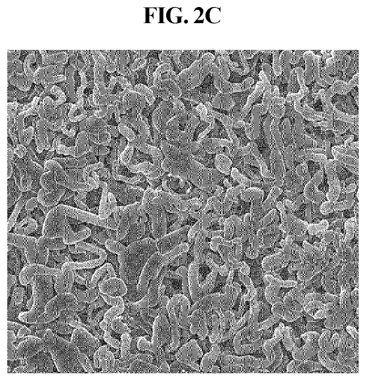

The morphology of the lithium metal batteries manufactured according to Example 1 and Comparative Examples 1 and 3 was observed during the electrodeposition of lithium, and the results are shown in FIGS. 2A to 2C.

Referring to FIG. 2A to 2C, it could be confirmed that lithium was electroplated more densely in a fiber-like form in Comparative Example 1 than in Comparative Example 3 and in Example 1 than in Comparative Example 1. Accordingly, it can be seen that local current density is reduced as LiNO₃ and LiDFBP are added as the reductive decomposable additive, which is advantageous in the evaluation of high current density.

### Experimental Example 3: Structural Changes of Protective Film According to Application of Reductive Decomposable Additive

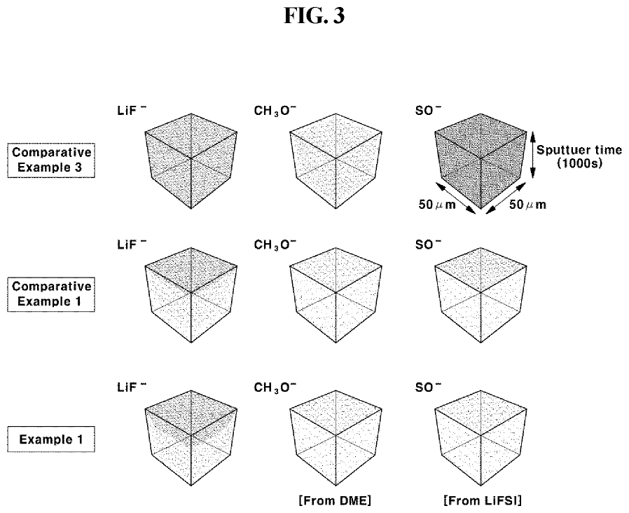

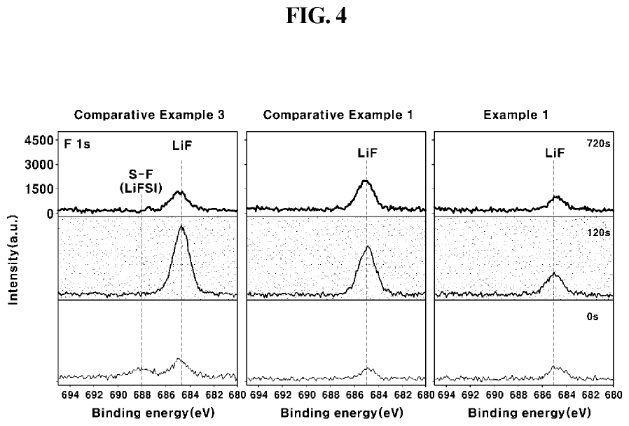

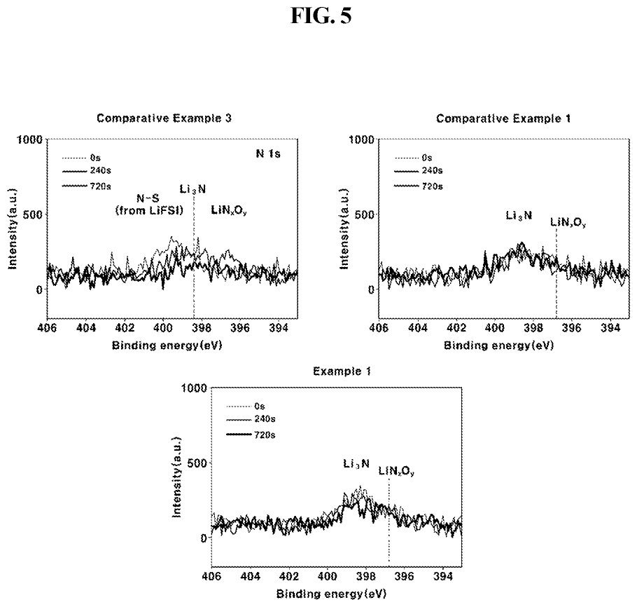

The film structures formed on the surfaces of the lithium metal electrodes of the Li/Cu lithium metal cells manufactured according to Example 1 and Comparative Examples 1 and 3 were observed using 3D-TOF-SIMS, and the results are shown in FIG. 3.

[Evaluation Standard]
Analysis of time-of-flight secondary ion mass spectroscopy (TOF-SIMS):
Observation of the lithium metal surface after electrodeposition of lithium metal on a copper substrate at a rate of 0.1C

Referring to FIG. 3, it could be confirmed that the protective film of the lithium metal battery manufactured according to Comparative Example 3 included the decomposition products (CH₃O⁻ and SO⁻) caused by the decomposition of salt and that LiF formed through the decomposition of salt was distributed in an excessive amount in the whole film. Accordingly, it could be confirmed that an excessive amount of electrolyte decomposition products was obtained due to continuous electrolyte decomposition.

Further, it was confirmed that the amount of the decomposition product was generally less in the protective film of the lithium metal battery manufactured according to Comparative Example 1 than in the protective film of the lithium metal battery of Comparative Example 3 but that the same types of decomposition products of the electrolyte as in Comparative Example 3 were distributed therein. In particular, it could be confirmed that LiF caused by the decomposition of salt was present in the inner surface of the protective film adjacent to the lithium metal battery.

In contrast, unlike the cases of Comparative Examples 1 and 3, in the protective film of the lithium metal battery manufactured according to Example 1, the amount of the decomposition product of LiF is increased due to the reductive decomposition of LiDFBP, which is not an electrolyte but is a reductive decomposable additive, and the amount of the decomposition product resulting from the electrolyte is reduced.

### Experimental Example 4: Observation of Surface of Lithium Metal Anode after First Deposition of Lithium Metal Battery

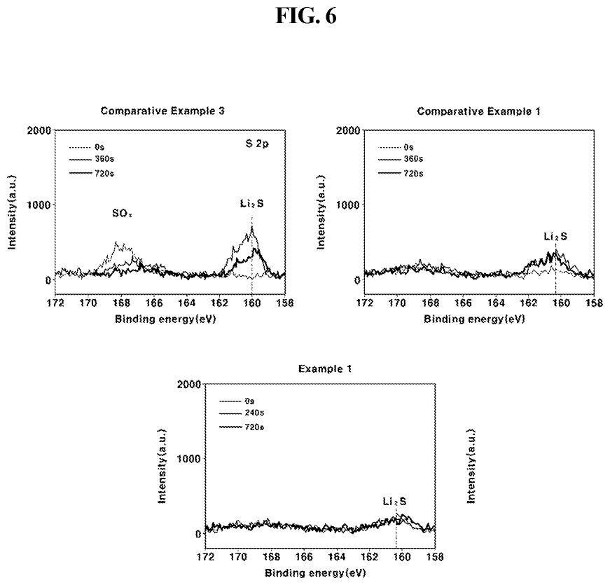

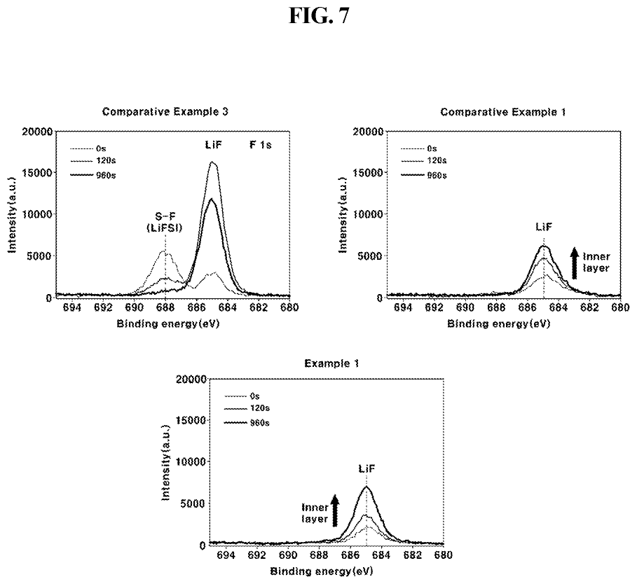

The surfaces of the lithium metal anodes of the lithium metal batteries manufactured according to Example 1 and Comparative Examples 1 and 3 were observed using XPS spectroscopy, and the results are shown in FIGS. 6 to 8.

Referring to FIG. 6, as a result of observing the surface around F 1s, it can be confirmed that the amount of LiF present in the protective film is gradually reduced from the case where an additive was not added (Comparative Example 3) to the case where the type of additive is LiNO₃ (Comparative Example 1) or the case where both LiNO₃ and LiDFBP are added (Example 1). Accordingly, it could be seen that the reductive decomposable additive preferentially formed a protective film, thereby inhibiting the decomposition of the salt contained in the electrolyte. Further, for the surface of the anode of the lithium metal battery of Example 1, a strong LiF peak occurred at about 120 s. Accordingly, it could be confirmed that a dominant layer of LiF was present.

Referring to FIG. 5, as a result of observing the surface around N 1s, on the surface of the anode of the lithium metal battery to which the additive was not added (Comparative Example 3), the peak was observed to be nonuniform according to the depth due to the decomposition of salt. In contrast, on the surface of the anode of the lithium metal battery to which LiNO₃ was added as the additive (Comparative Example 1), the peak was observed to be relatively uniform according to the depth due to the decomposition of LiNO₃ compared to the case of Comparative Example 3. Further, on the surface of the anode of the lithium metal battery to which LiNO₃ and LiDFBP were added as the additive (Example 1), as in the case of Comparative Example 1, the peak was observed to be relatively uniform according to the depth due to the decomposition of LiNO₃, compared to the case of Comparative Example 3.

Referring to FIG. 6, as a result of observing the surface around S 2p, on the surface of the anode of the lithium metal battery to which the additive was not added (Comparative Example 3), a strong peak was observed due to the decomposition of salt. In contrast, on the surface of the anode of the lithium metal battery to which LiNO₃ was added as the additive (Comparative Example 1), a relatively weak salt decomposition peak was observed compared to the case of Comparative Example 3. This is similar to the trend of TOF-SIMS evaluation of Experimental Example 3. Further, on the surface of the anode of the lithium metal battery to which LiNO₃ and LiDFBP were added as the additive (Example 1), the weakest salt decomposition peak was observed. Accordingly, it could be confirmed that since the amount of the reductive decomposition material caused by the decomposition of salt was the smallest, the lithium metal battery (Example 1) had the longest lifespan.

### Experimental Example 5: Observation of Surface of Lithium Metal Anode of Lithium Metal Battery after Seven Cycles

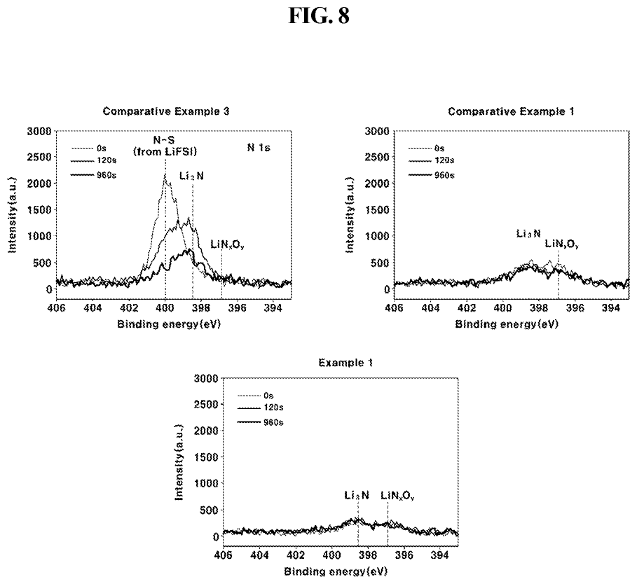

After the lithium metal batteries manufactured according to Example 1 and Comparative Examples 1 and 3 were operated for seven cycles, the surfaces of the lithium metal anodes thereof were observed using XPS spectroscopy, and the results are shown in FIGS. 7 to 10.

Referring to FIG. 7, as a result of observing the surface around F 1s, on the surface of the anode of the lithium metal battery to which the additive was not added (Comparative Example 3), a strong peak of LiF caused by the decomposition of salt was observed. In contrast, on the surface of the anode of the lithium metal battery to which LiNO₃ was added as the additive (Comparative Example 1), a relatively weak peak of LiF caused by the decomposition of salt was observed compared to the case of Comparative Example 3. Accordingly, it can be confirmed that the decomposition of the salt is relatively inhibited due to LiNO₃, which is a reductive decomposable additive. Further, on the surface of the anode of the lithium metal battery to which LiNO₃ and LiDFBP were added as the additive (Example 1), the weakest peak of LiF was observed compared to the cases of Comparative Examples 1 and 3. Accordingly, it can be confirmed that the peak of LiF is formed due to defluorination of LiDFBP, not due to the decomposition of salt. Further, it can be observed that the peak intensity of LiF is increased over time. Accordingly, it can be confirmed that LiF is mainly distributed in the inner side of the protective film adjacent to the lithium metal battery.

That is, LiF, which is the reductive decomposition material formed on the surface of the anode of the lithium metal battery according to the present disclosure, is mainly distributed on the inner side of the protective film adjacent to the lithium metal battery. Accordingly, ion conductivity is improved, and mechanical properties are mainly improved so as to withstand lithium volume expansion of the lithium metal anode under a high-specific-capacity condition.

Referring to FIG. 8, as a result of observing the surface around N 1s, on the surface of the anode of the lithium metal battery to which the additive was not added (Comparative Example 3), strong peaks of N—S and Li₃N caused by the decomposition of salt were observed. In contrast, on the surface of the anode of the lithium metal battery to which LiNO₃ was added as the additive (Comparative Example 1), a weak and uniform peak of Li₃N caused by the decomposition of LiNO₃, which was the reductive decomposable additive, was observed compared to the case of Comparative Example 3. Further, on the surface of the anode of the lithium metal battery to which LiNO₃ and LiDFBP were added as the additive (Example 1), like the case of Comparative Example 1, a weak and uniform peak of Li₃N caused by the decomposition of LiNO₃, which was the reductive decomposable additive, was observed compared to the case of Comparative Example 3.

That is, Li₃N, which is the reductive decomposition material formed on the surface of the anode of the lithium metal battery according to the present disclosure, is uniformly distributed throughout the protective film. Accordingly, it could be confirmed that mechanical properties were improved and that ion conductivity was improved under a high-current-density condition.

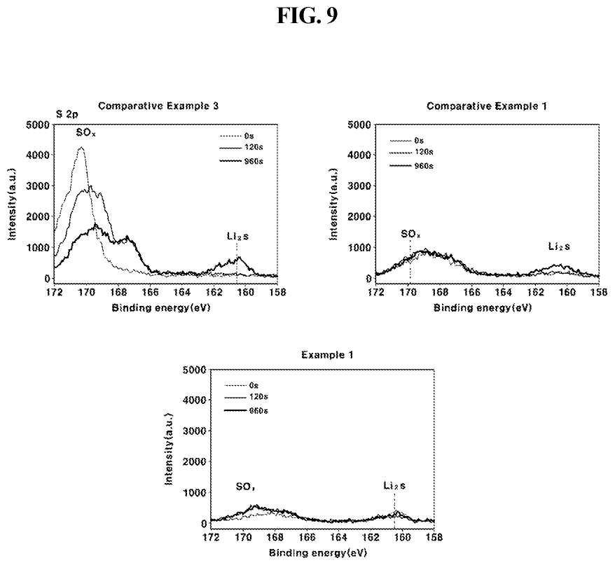

Referring to FIG. 9, as a result of observing the surface around S 2p, on the surface of the anode of the lithium metal battery to which the additive was not added (Comparative Example 3), a strong peak was observed due to the decomposition of salt. In contrast, on the surface of the anode of the lithium metal battery to which LiNO₃ was added as the additive (Comparative Example 1), a relatively weak salt decomposition peak was observed compared to the case of Comparative Example 3. Further, on the surface of the anode of the lithium metal battery to which LiNO₃ and LiDFBP were added as the additive (Example 1), the weakest salt decomposition peak was observed. Accordingly, it could be confirmed that the lithium metal battery (Example 1) had the longest lifespan because the amount of the reductive decomposition material formed by the decomposition of salt was the smallest in that case.

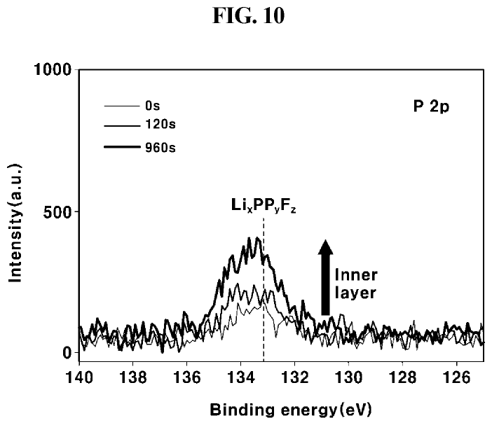

Referring to FIG. 10, as a result of observing the surface around P 2p, on the surface of the anode of the lithium metal battery to which LiNO₃ and LiDFBP were added as the additive (Example 1), a relatively uniform peak of LiₓPO_{y}F_{z} (0.1≤x≤1, 2≤y≤3, 1≤z≤2) was observed according to the depth, as in the observation of the surface around N 1s. Accordingly, it could be confirmed that LiₓPO_{y}F_{z} was distributed throughout the protective film. Further, as in the observation of the surface around F 1s, it can be observed that the peak intensity increases over time. Accordingly, it can be confirmed that LiₓPO_{y}F_{z} (0.1≤x≤1, 2≤y≤3, 1≤z≤2) is distributed throughout the protective film and is mainly distributed in the inner side of the protective film adjacent to the lithium metal battery.

Therefore, the electrolyte for the lithium metal battery according to the present disclosure includes lithium nitrate (LiNO₃) and lithium difluorobis(oxalate) phosphate (LiDFBP) as a reductive decomposable additive, so that a stable protective film is formed on the surface of a metal anode. Accordingly, mechanical properties are improved so as to withstand lithium volume expansion under a high-specific-capacity condition, and ion conductivity is improved under a high-current-density condition, thereby improving the stability and performance of the lithium metal battery including the protective film.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. An electrolyte for a lithium metal battery, the electrolyte comprising:
a lithium salt;
an organic solvent; and
a reductive decomposable additive;
wherein the reductive decomposable additive includes lithium nitrate (LiNO₃) and lithium difluorobis(oxalate) phosphate (LiDFBP), and the reductive decomposable additive is reductively decomposed before the organic solvent is decomposed, thus forming a protective film on a surface of a lithium metal anode.

2. The electrolyte for the lithium metal battery of claim 1, wherein the reductive decomposable additive is included with a content of 0.1 to 10 wt % based on 100 wt % of a total weight of the electrolyte for the lithium metal battery.

3. The electrolyte for the lithium metal battery of claim 1, wherein a mass ratio of the lithium nitrate (LiNO₃) to the lithium difluorobis(oxalate) phosphate (LiDFBP) included in the reductive decomposable additive is 4 to 6:1.

4. The electrolyte for the lithium metal battery of claim 1, wherein the lithium salt is included with a concentration of 1.5 to 3 mol per 1 L of the electrolyte for the lithium metal battery.

5. The electrolyte for the lithium metal battery of claim 1, wherein the lithium salt includes one or more selected from the group consisting of LiFSI, LiTFSI, LiPF₆, LiBF₄, LiSbF₆, LiAsF₆, LiN(SO₂CF₃)₂, LiN(SO₃C₂F₅)₂, LiC₄F₉SO₃, LiClO₄, LiAlO₂, LiAlCl₄, LiCl, and LiI.

6. The electrolyte for the lithium metal battery of claim 1, wherein the organic solvent includes one or more selected from the group consisting of dimethyl ether (DME), 1,2-dimethoxy ethane, 1,3-dioxolane, diethylene glycol, tetraethylene glycol, diethylene glycol dimethyl ether, triethylene glycol dimethyl ether, and tetraethylene glycol dimethyl ether.

7. A lithium metal battery comprising:
a cathode;
an anode;
the electrolyte for the lithium metal battery of any one of claims 1 to 6; and
a protective film formed on a surface of the anode;
wherein the protective film includes reductive decomposition materials of lithium nitrate (LiNO₃) and lithium difluorobis(oxalate) phosphate (LiDFBP).

8. The lithium metal battery of claim 7, wherein the protective film stabilizes an interface between a lithium metal anode and the electrolyte for the lithium metal battery.

9. The lithium metal battery of claim 7, wherein the reductive decomposition materials include one or more selected from the group consisting of LiF, Li₃N, and LiₓPO_{y}F_{z} (0.1≤x≤1, 2≤y≤3, 1≤z≤2) in a large amount.

10. The lithium metal battery of claim 9, wherein the LiF is mainly distributed on an inner side of a protective film adjacent to the lithium metal battery.

11. The lithium metal battery of claim 9, wherein the Li₃N is uniformly distributed throughout a protective film.

12. The lithium metal battery of claim 9, wherein the LiₓPO_{y}F_{z} (0.1≤x≤1, 2≤y≤3, 1≤z≤2) is distributed throughout a protective film and is mainly distributed on an inner side of the protective film adjacent to the lithium metal battery.
